(19) United States
(12) Patent Application Publication
(10) Pub. No.: US 2018/0051491 A1
(43) Pub. Date: Feb. 22, 2018

(54) WHEELED BOARD AND ACCESSORIES RACK

(71) Applicant: TANAWAA LLC, Parker, CO (US)

(72) Inventor: Nicholas CHESTERTON, Chico, CA (US)

(21) Appl. No.: 15/797,089

(22) Filed: Oct. 30, 2017

Related U.S. Application Data
(62) Division of application No. 14/820,841, filed on Aug. 7, 2015, now Pat. No. 9,834,960.

(51) Int. Cl. E05B 73/00; A63C 17/00; E05B 73/02

(52) U.S. Cl. CPC E05B 73/0094; A63C 2203/44; E05B 73/02; A63C 17/0006

(57) ABSTRACT

A rack to hold skateboards, longboards, scooters, motorcycle helmets, purses, umbrellas and other implements or accessories. The rack is adapted to be mounted on a wall or surface. The rack is formed of a lip extending from a rear support. The lip is formed of a series of rounded protrusions. Items to be held by the rack can be received over the protrusions. In one embodiment, each protrusion is angled at a predetermined angle from the front. This helps keep a received skateboard, scooter or other accessory at an appropriate angle such that the wheels or surface of the accessory will remain off an affixed wall to avoid damage to wall. The rack can also include a locking mechanism for locking adjacent protrusions. The rack is designed for safety by having rounded edges on all areas that protrude from the wall.

### BACKGROUND OF THE INVENTION

### Field of the Invention

The present invention relates generally to racks for sporting goods equipment and in particular to an improved rack for retaining a plurality of wheeled boards and/or accessories which prevents damage to affixed walls.

### Description of Related Art

Skateboard racks for holding skateboards have been described. U.S. Pat. No. 6,293,412 describes a skateboard rack including a pair of struts spaced from one another by a cross bar. At the bottom of each of the struts is an elbow that terminates upwardly. Wheels of the skateboard can rest on the elbows to hang the skateboard on the rack. Aligned apertures in the cross bar and the elbow can receive a lock. In a skateboard assembly, a plurality of the individual skateboard racks are individually connected to horizontal bars. The horizontal bars are connected to vertical posts. This skateboard rack has the shortcoming that during use, the lower wheels contact the wall to which the skateboard rack is attached.

U.S. Pat. No. 7,014,052 describes a wall hanger for a skateboard having a mountable panel with two spaced apart upwardly arched hooks mounted on a panel. The upwardly arched hooks receive skateboard wheels or a scooter handle bar. An outwardly arched spacer arm below the hooks contacts the board or scooter to maintain the board or scooter away from the wall. This skateboard rack has the shortcoming that the arched spacer arm increases manufacturing costs, the arched spacer arm takes up additional space and can harm an individual that may bump or fall against the rack. It is desirable to provide an improved wheeled board and accessories rack of a one-piece construction having low manufacturing costs and providing safety.

### SUMMARY OF THE INVENTION

The present invention relates to a rack to hold skateboards, longboards, scooters, motorcycle helmets, purses, umbrellas and other implements or accessories. The rack is adapted to be mounted on a wall or surface. The rack is formed of a lip extending from a rear support. The lip is formed of a series of rounded protrusions. Items to be held by the rack can be received over the protrusions. In one embodiment, adjacent protrusions hold wheels of a skateboard and a truck of the skateboard is positioned in a notch extending between the adjacent protrusions. The rack can be designed to fit any style of skateboard, scooter or accessory. The rack design allows multiple skateboards and/or other items to be mounted consecutively.

In one embodiment, each protrusion is angled at a predetermined angle from the front. This helps keep a received skateboard, longboard, scooter or other accessory at an appropriate angle such that the wheels or surface of the accessory will remain off an affixed wall to avoid damage to wall. The rack is designed for safety by having rounded edges on all areas that protrude from the wall. The rack can be flush mounted to the wall with a minimal amount of protrusion. Accordingly, the rack is safe for use in the home or public places and complies with health and safety regulations, for example the health and safety regulations mandated by the State of California.

In an alternate embodiment, the rack includes a locking mechanism for locking adjacent protrusions. Rotatable locking arms are attached to adjacent protrusions. The locking arms can be rotated over a received item. The locking arms include one or more locking apertures. The apertures of the adjacent locking arms can be aligned and a locking device can be received in the aligned locking apertures. In one embodiment, each locking arm includes three locking apertures at a 60 degree angle to one another to provide varied locking combinations. The locking arms can be used by pedestrians to lock up skateboards or scooters in public places as well as accessories, such as backpacks, purses, umbrellas or other items brought into the public place for example a classroom or building. The locking rack provides theft protection and provides protection for items from accidentally being knocked out of the rack or falling out of the rack in the event of an earthquake.

The invention will be more fully described by reference to the following drawings.

### BRIEF DESCRIPTION OF THE DRAWINGS

FIG. 1A is a perspective view of a wheeled board and accessories rack in accordance with the teachings of the present invention.

FIG. 1B is a front view of the wheeled board and accessories rack.

FIG. 1C is a top plan view of the wheeled board and accessories rack.

FIG. 1D is a detail view of FIG. 1B.

FIG. 1E is a right side view of the wheeled board and accessories rack.

FIG. 1F is a perspective view of the lip.

FIG. 2A is a schematic diagram of the wheeled board and accessories rack during operation.

FIG. 2B is a schematic diagram of the wheeled board and accessories rack during operation for retaining a skateboard and long board.

FIG. 2C is a schematic diagram of the wheeled board and accessories rack during operation for retaining a skateboard and long board.

FIG. 3A is a perspective view of a wheeled board and accessories rack in accordance with the teachings of the present invention.

FIG. 3B is a front view of the wheeled board and accessories rack shown in FIG. 3A.

FIG. 3C is a top plan view of the wheeled board and accessories rack shown in FIG. 3A.

FIG. 3D is a detail view of feature B of FIG. 3B.

FIG. 3E is a right side view of the wheeled board and accessories rack shown in FIG. 3A.

FIG. 3F is a perspective view of the lip.

FIG. 4A is a perspective view of a wheeled board and accessories rack including a locking device in accordance with the teachings of the present invention.

FIG. 4B is a schematic front view of the wheeled board and accessories rack shown in FIG. 4A showing connections of the locking devices.

FIG. 4C is a detail view of FIG. 4B.

FIG. 4D is a right side view of the wheeled board and accessories rack.

FIG. 4E is a perspective view of the lip.

FIG. 5A is a rear view of the wheeled board and accessories rack shown in FIG. 4A.

FIG. 5B is a detail view of FIG. 5A.

FIG. 5C is a detailed front view of the locking arm.

FIG. 5D is a detailed perspective view of the locking arm.

FIG. 6 is a schematic diagram of the wheeled board and accessories rack including a locking device during operation.

FIG. 7A is a perspective view of a wheeled board and accessories rack in accordance with the teachings of the present invention.

FIG. 7B is a front view of the wheeled board and accessories rack shown in FIG. 7A.

FIG. 7C is a top plan view of the wheeled board and accessories rack shown in FIG. 7A.

FIG. 7D is a detail view of feature A of FIG. 7B.

FIG. 7E is a right side view of the wheeled board and accessories rack shown in FIG. 7A.

FIG. 8A is a schematic diagram of the wheeled board and accessories rack including a locking device during operation.

FIG. 8B is a schematic diagram of the wheeled board and accessories rack including a locking device during operation.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

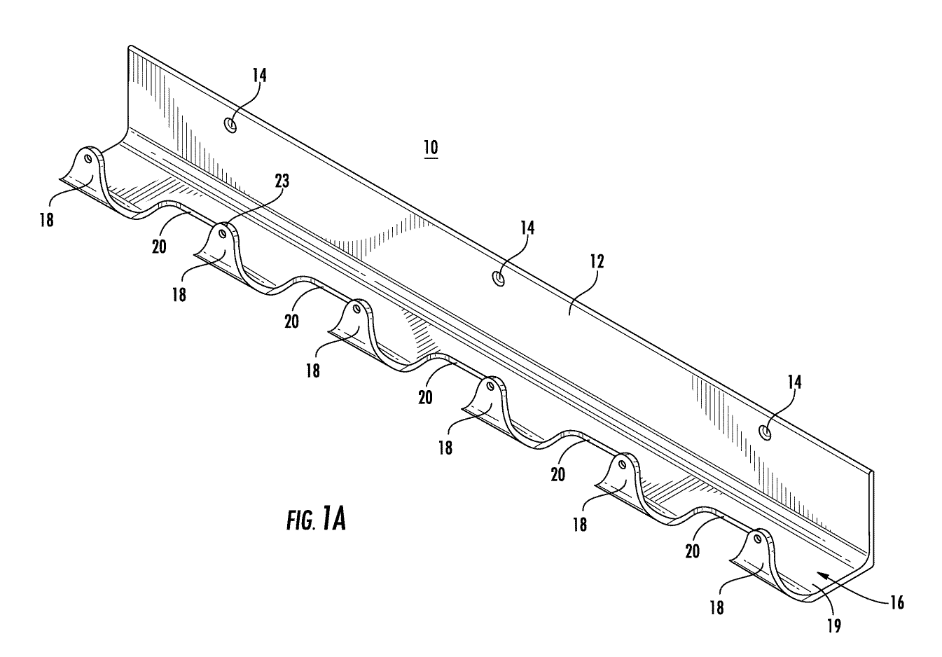

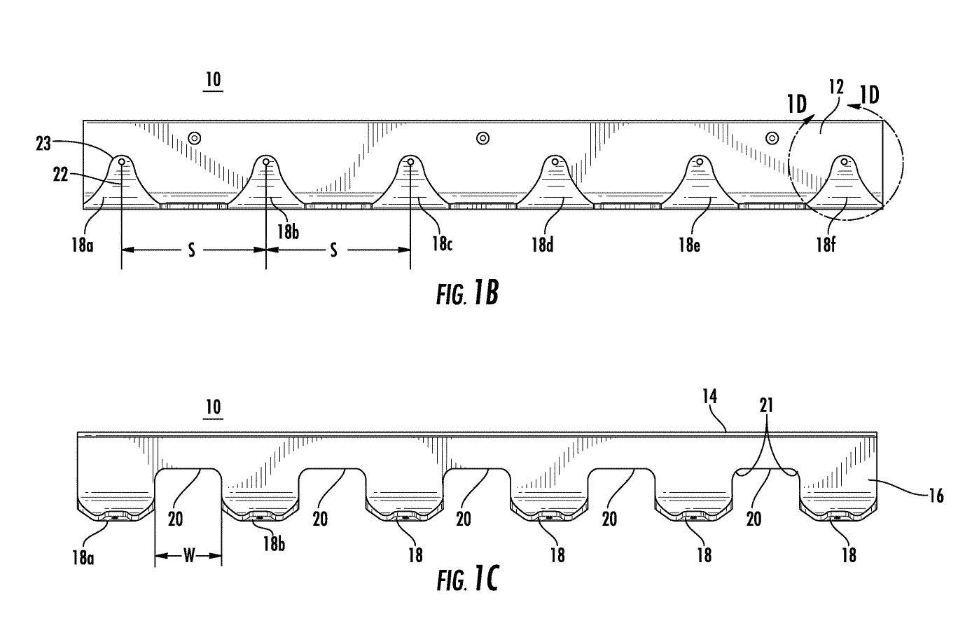

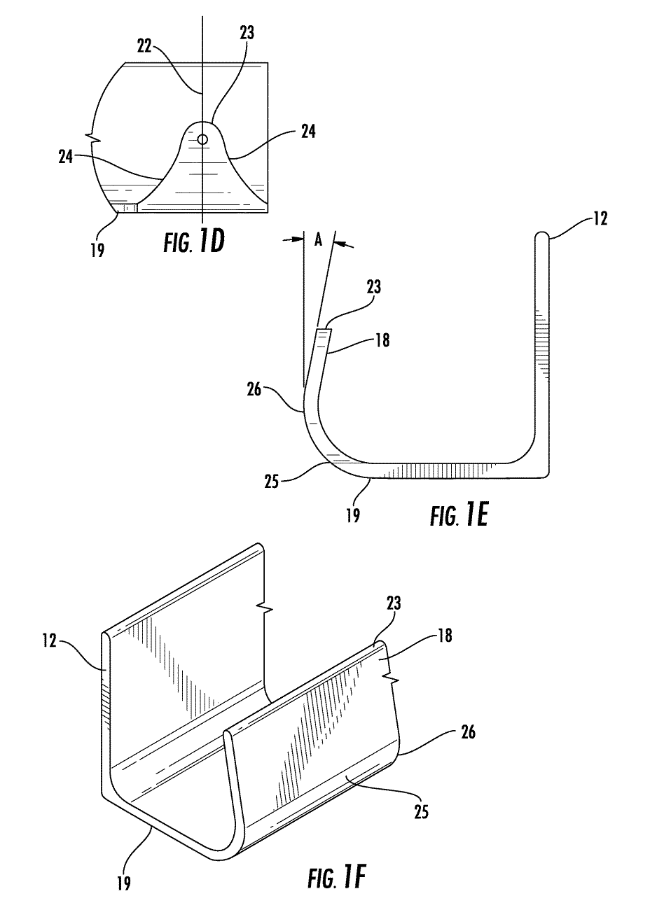

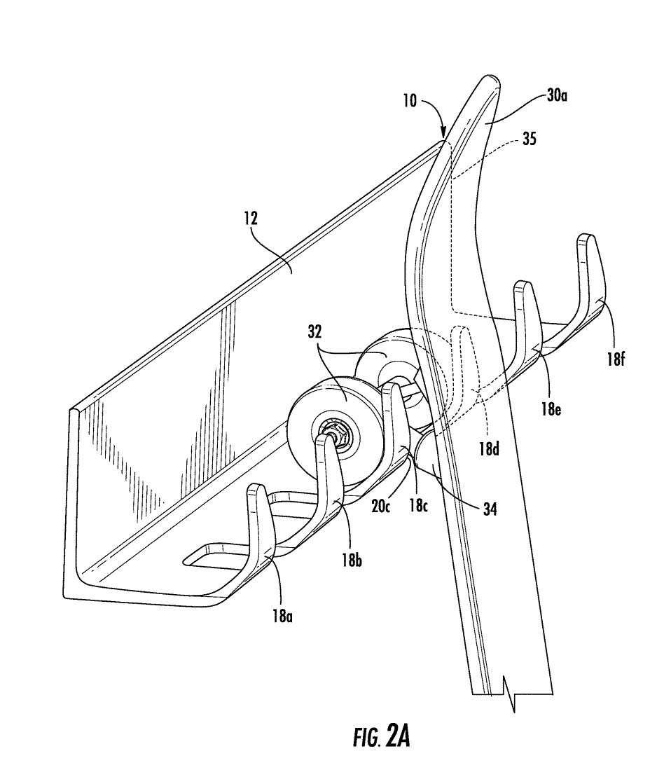

FIGS. 1A-1E illustrate an embodiment of wheeled board and accessories rack 10 in accordance with the teachings of the present invention. Rear support 12 includes a plurality of apertures 14 as shown in FIG. 1A. Apertures 14 can receive attachment devices not shown for attaching rack 10 to a surface or wall.

Lip 16 extends substantially horizontally from rear support 12. Lip 16 includes a plurality of protrusions 18 extending from base support 19. Base support 19 can be substantially perpendicular to rear support 12. Notches 20 are positioned between adjacent protrusions 18.

In this embodiment six protrusions 18 are formed in rack 10. Each of protrusions 18 have the same size and each of notches 20 have the same size to allow protrusions 18 to be evenly spaced from one another. The spacing S between vertical axis 22 of adjacent protrusions 18a and 18b and vertical axis 22 of adjacent protrusions 18b and 18c is the same, as shown in FIG. 1B. In a preferred embodiment, spacing S is about six inches. In one embodiment, notch 20 can have a width W sufficient to accommodate a truck which attaches to skateboard wheels or to a scooter, as shown in FIG. 1C. An example scooter, is manufactured by RAZOR. For example, notch 20 can have a width W in the range of about 2.0 inches to about 4.0 inches. Preferably, width W is about 2.9 inches. Notches 20 can include rounded corners 21. Protrusions 18 can have a rounded top portion 23, as shown in FIG. 1D. Top portion 23 can be rounded in a semi-circular shape. Each protrusion 18 is vertically symmetric around vertical axis 22. Protrusion 18 includes curved side walls 24 extending to base support 19. Bottom portion 25 of front wall 26 of protrusion 18 is curved from base support 19, as shown in FIG. 1E and FIG. 1F. Top portion 23 of front wall 26 of protrusion 18 is angled toward rear support 12. Top portion 23 can be angled at an angle A in the range of about 5 degrees to about 15 degrees. In a preferred embodiment angle A is about 10 degrees.

Rack 10 can have a length in the range of about 20 inches to about 40 inches. In a preferred embodiment of rack 10 including six protrusions 18, rack 10 has a length of about 33 inches.

Rear support 12 and lip 16 can be integral to one another. In one embodiment rack 10 is formed of a one-piece construction of an extrusion of a metal or plastic material. For example the metal material can be aluminum or recycled aluminum.

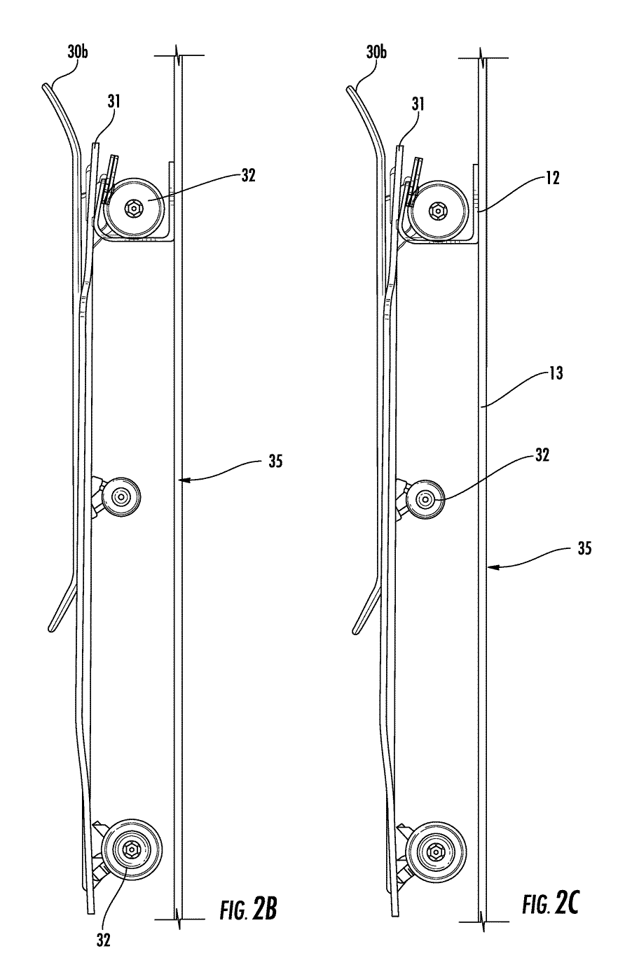

FIG. 2 illustrates operation of rack 10 for retaining skateboard 30a. Skateboard 30a includes wheels 32 connected by truck 34 to skateboard 30a. Wheels 32 are retained by adjacent protrusions 18c and 18d. Truck 34 is positioned within notch 20c. Notch 20c is positioned between protrusions 18c and 18d. Angle A of top portion 23 of lip prevents skateboard 30 from contacting wall 35. FIGS. 2B-2C shown rack 10 attached to wall 35. Skateboard 30b and longboard 31 are retained by rack 10. Angle A of top portion 23 of lip prevents longboard 31 from contacting wall 35, as shown in FIG. 2B. Angle A of top portion 23 of lip prevents skateboard 30b from contacting wall 35, as shown in FIG. 2C. Alternatively, protrusions 18 can be used to retain scooters or accessories including for example backpacks, purses, umbrellas, helmets, and the like.

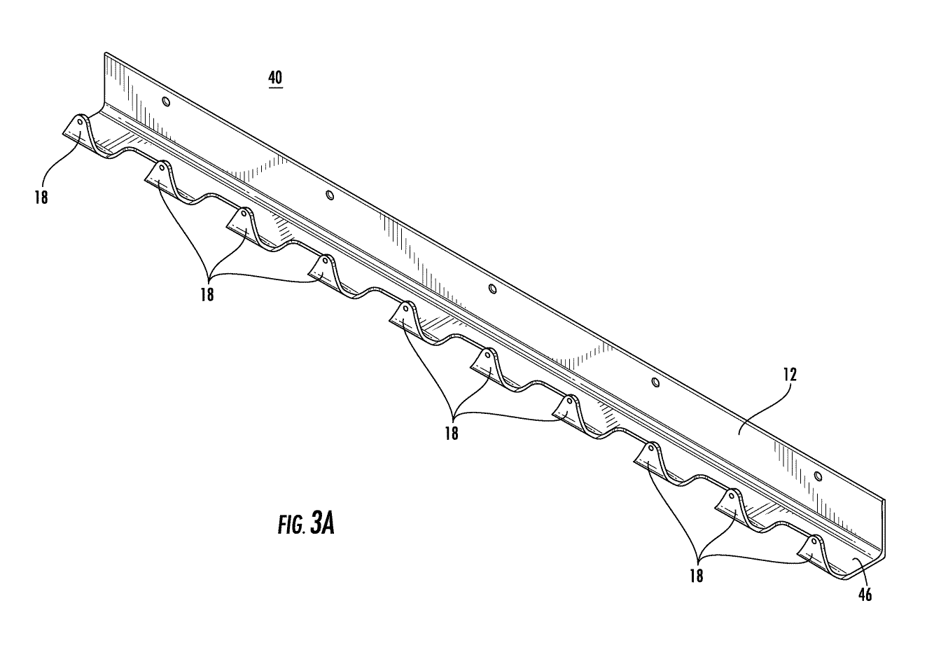

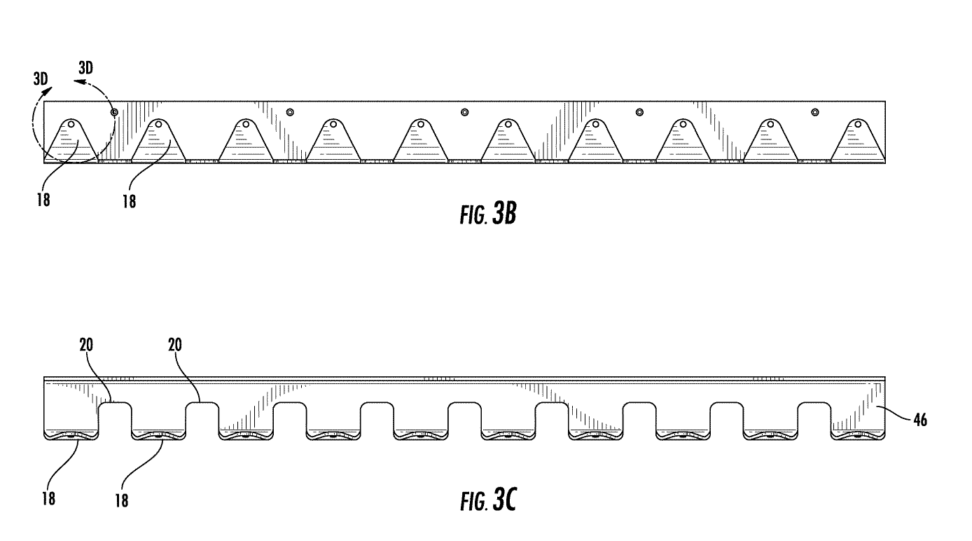

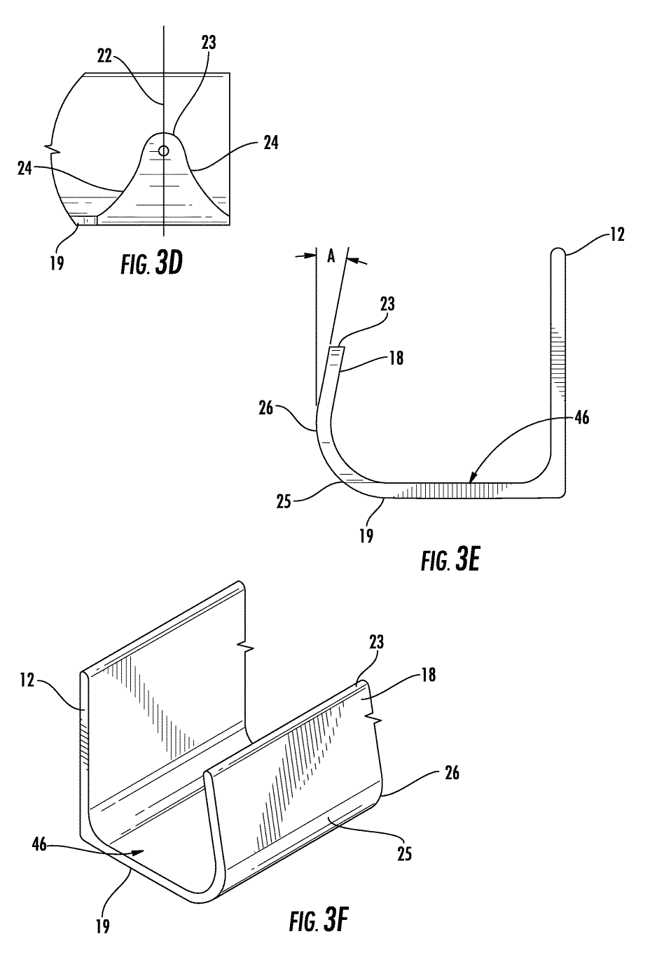

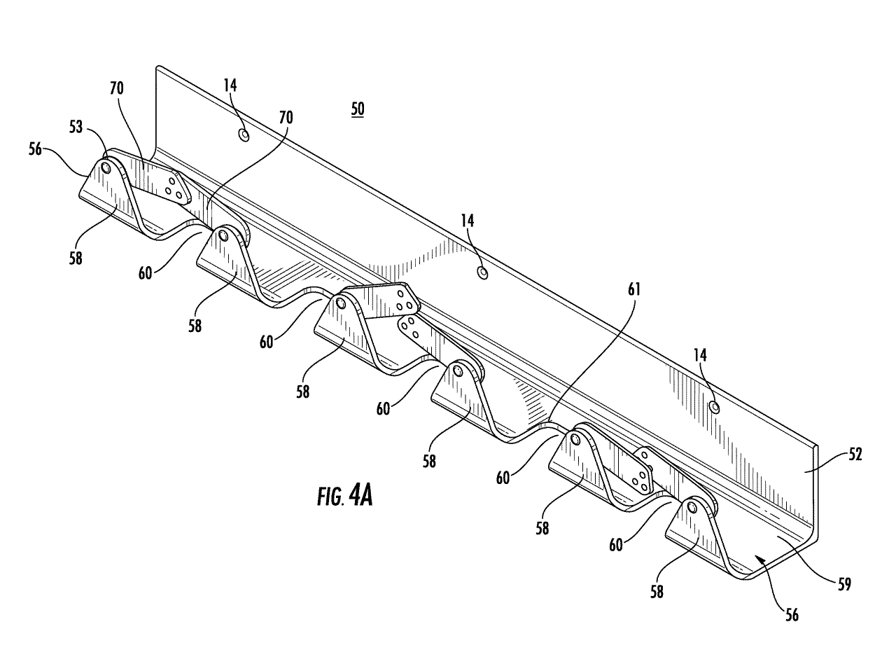

FIGS. 3A-3E illustrate an alternate embodiment of wheeled board and accessories rack 40 in accordance with the teachings of the present invention. In this embodiment, lip 46 is formed of ten protrusions 18.

Rack 40 can have a length in the range of about 40 inches to about 60 inches. In a preferred embodiment of rack 40 including ten protrusions, rack 40 has a length of about 56 inches. It will be appreciated that in accordance with the teachings of the present invention a rack can be formed of any length with any number of protrusions.

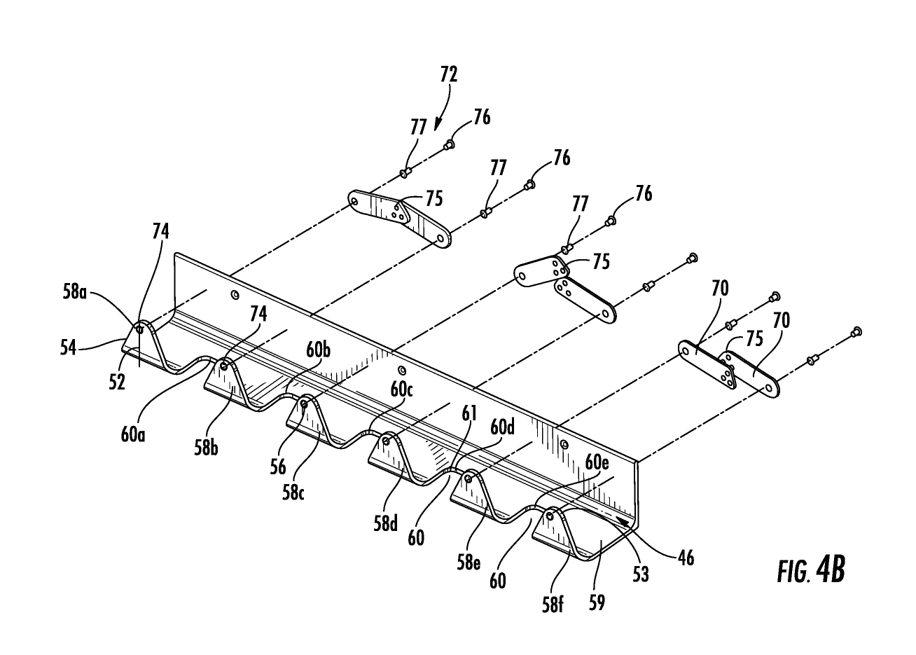

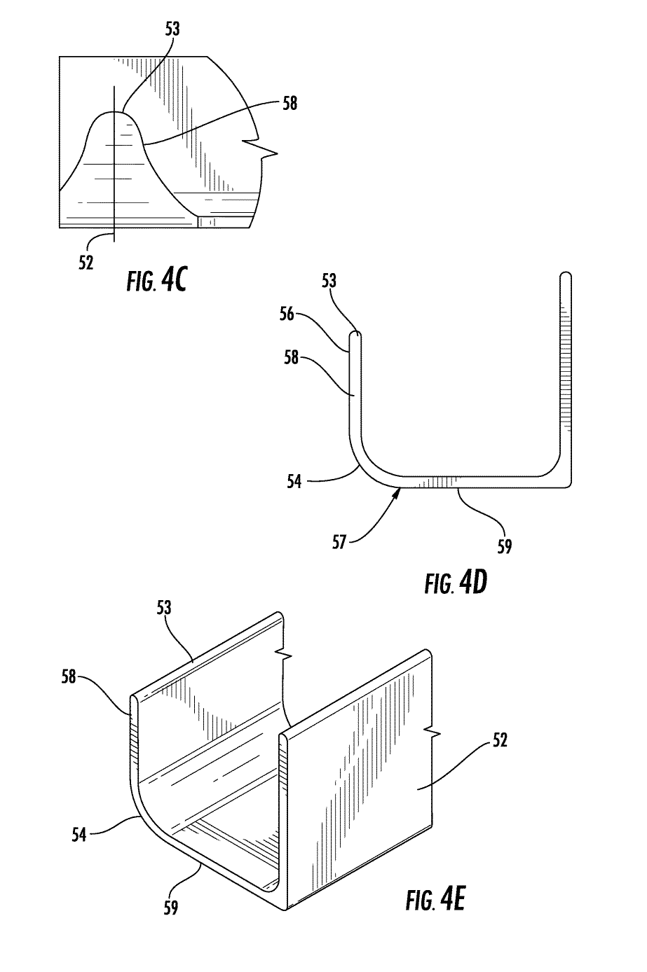

FIGS. 4A-4G illustrate an alternate embodiment of wheeled board and accessories locking rack 50. Lip 56 extends substantially horizontally from rear support 52, as shown in FIG. 4A. Lip 56 is formed a plurality of protrusions 58 extending from base support 59. Notches 60 are positioned between adjacent protrusions 58. Notches 60 include rounded corners 61. In this embodiment six protrusions 58 are formed in rack 50. Each of protrusions 58 have the same size and each of notches 60 have the same size to allow protrusions 58 to be evenly spaced from one another, as shown in FIG. 4B. Pivot 72 can include rivet 76 and bushing 77 attached to protrusion 78, as shown in FIG. 4C.

Protrusions 58 have a rounded top portion 53. Top portion 53 can be rounded in a semi-circular shape. Each protrusion 58 is vertically symmetric around vertical axis 52. Protrusion 58 includes curved side walls 54 extending to base support 59, as shown in FIG. 4D. Front wall 56 of protrusion 58 is substantially perpendicular to base support 59, as shown in FIG. 4E.

Locking arm 70 is rotatably coupled to a respective protrusion 58. Locking arm 70 can be coupled with pivot 72 to aperture 74, as shown in FIGS. 4C-4D. Aperture 74 is positioned at top portion 53 of protrusion 70. Locking arm 70 includes one or more locking apertures 75.

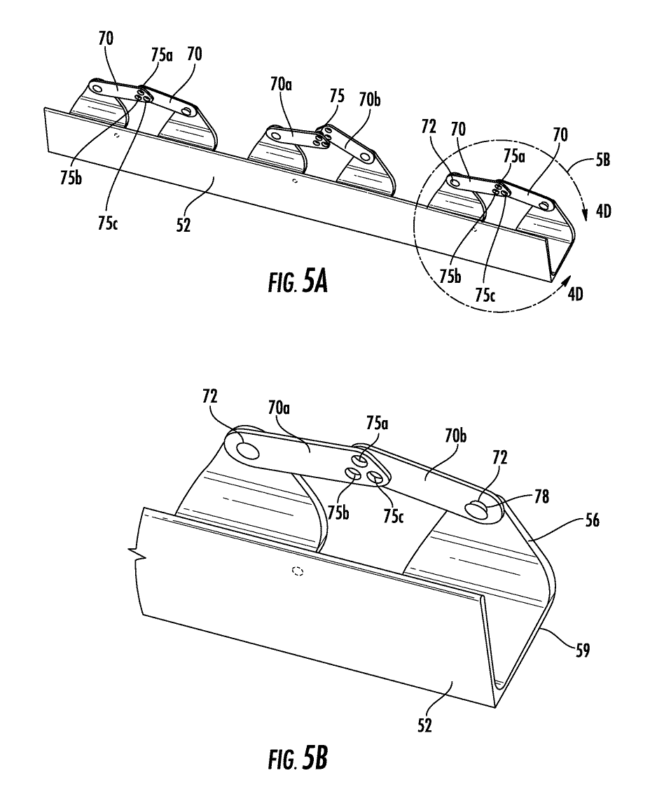

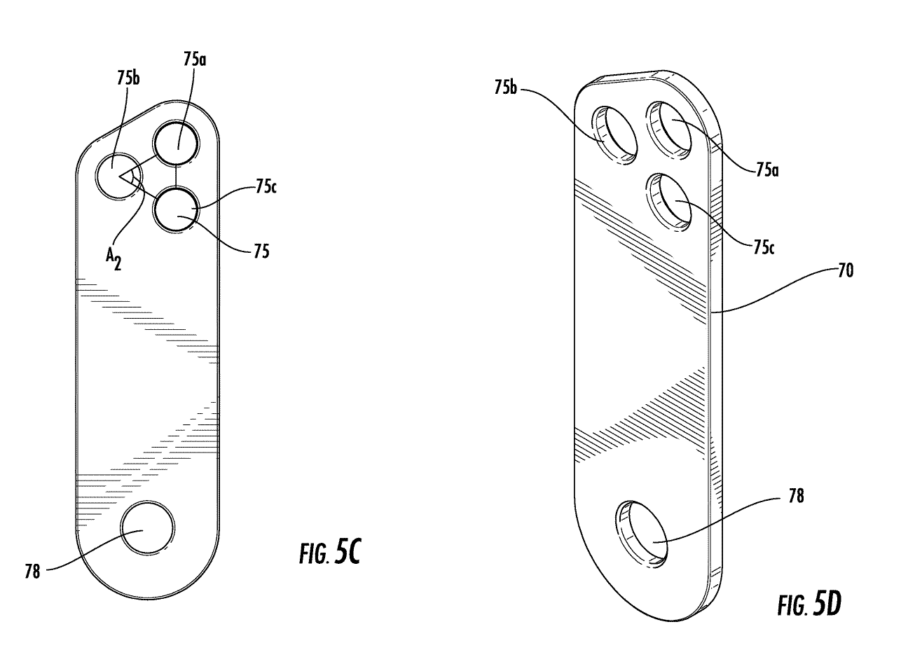

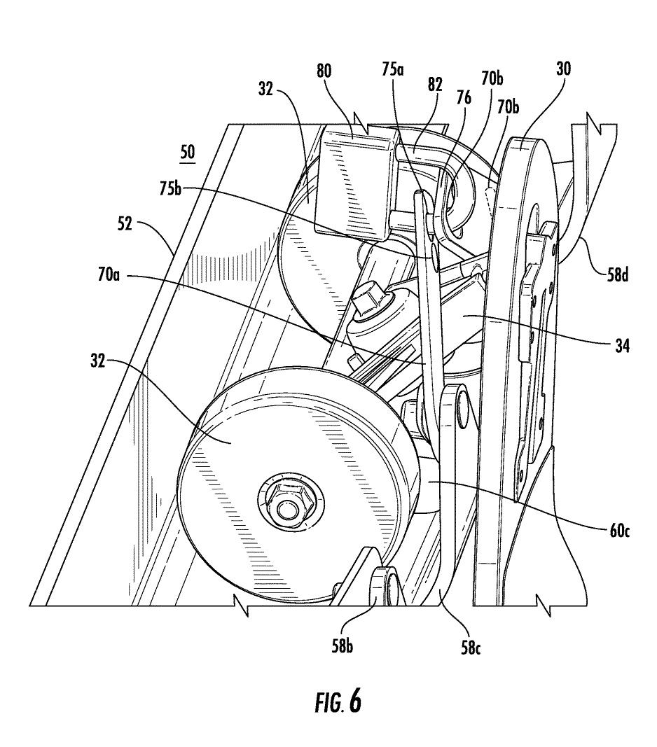

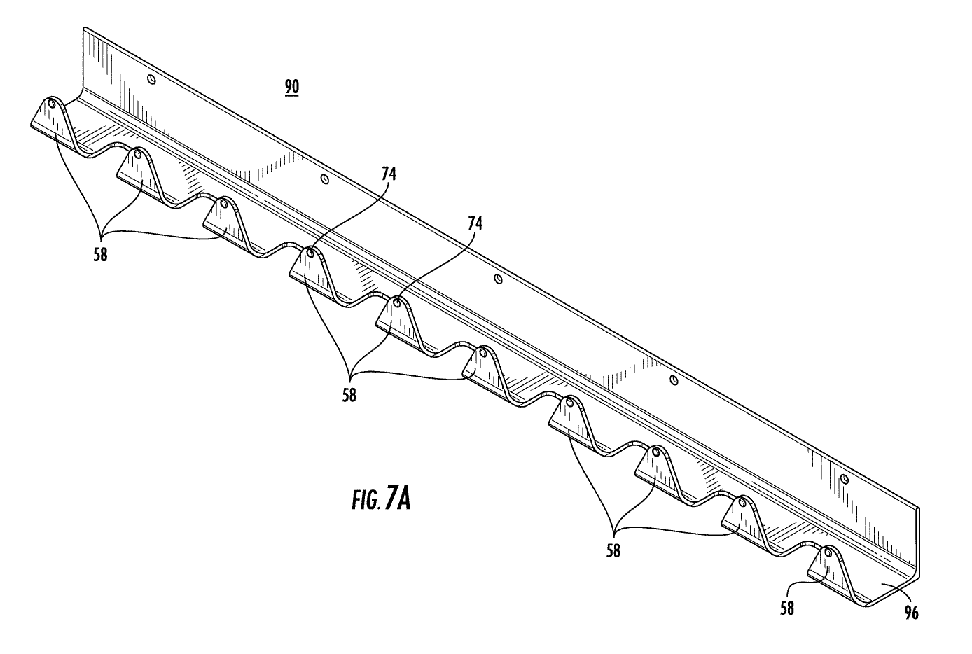

In one embodiment three locking apertures 75a-75c are formed in locking arm 70 in a triangular pattern of an angle A₂ of 60 degrees to one another, as shown in FIGS. 5A-5D. Pivot 72 allows locking arm 70a to swivel in aperture 78 for lining up at least one of locking apertures 75a-75c of locking arm 70a with at least one adjacent locking apertures 75a-75c of locking arm 70b for providing various locking combinations. Locking rack 50 can be slightly larger than rack 10 to accommodate all skateboards and allow the functionality of the locking mechanism.

FIG. 6 illustrates operation of locking rack 50 for locking skateboard 30 to locking rack 50. Wheels 32 are retained by adjacent protrusions 58c and 58d. Truck 34 is positioned within notch 60c. Notch 60c is positioned between protrusions 58c and 58d. One of locking apertures 75a, 75b or 75c of locking arm 70a is aligned with one of locking apertures 75a, 75b or 75c of locking arm 70b. Locking member 82 of lock 80 is received within the respective aligned locking apertures 75a, 75b or 75c of locking arm 70a and locking arm 70b. Locking member 82 is locked into lock 80. Lock 80 can be any conventional lock such as a padlock.

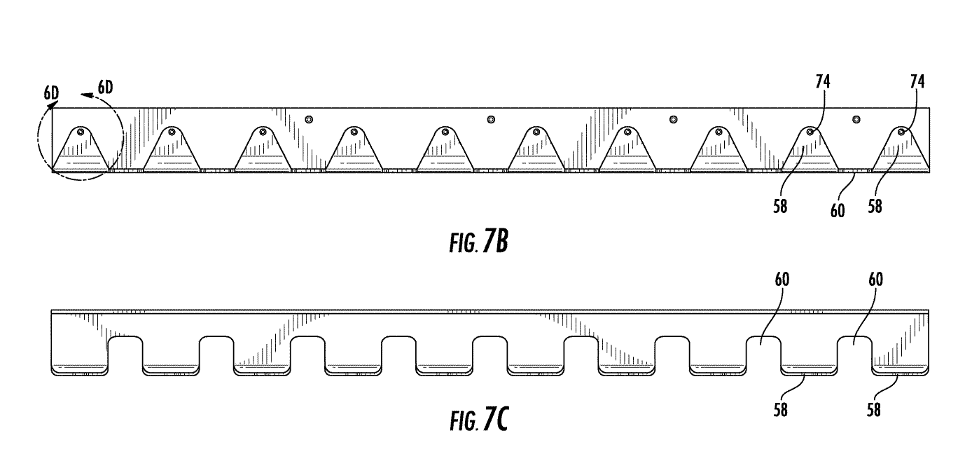

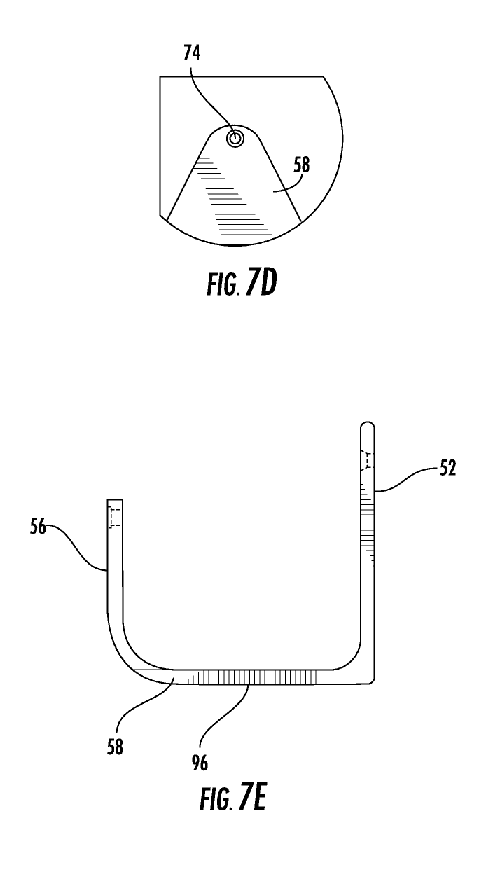

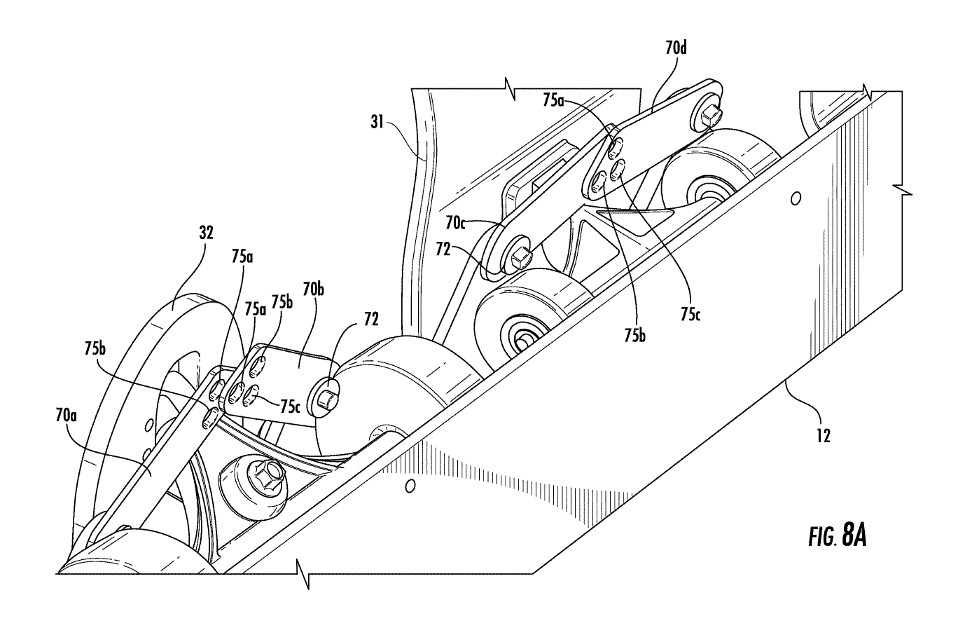

FIGS. 7A-7E illustrate an alternate embodiment of wheeled board and accessories locking rack 90 in accordance with the teachings of the present invention. In this embodiment, lip 96 is formed of ten protrusions 58.

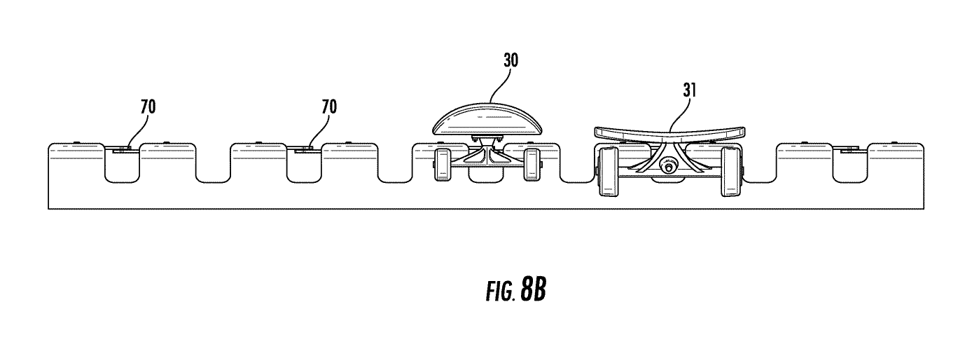

FIGS. 8A-8B illustrate operation of locking rack 50 for retaining skateboard 30 and longboard 31. One of locking apertures 75a, 75b or 75c of locking arm 70a is aligned with one of locking apertures 75a, 75b or 75c of locking arm 70b. One of locking apertures 75a, 75b or 75c of locking arm 70c is aligned with one of locking apertures 75a, 75b or 75c of locking arm 70d.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A locking rack for retaining a skateboard, scooter or accessory comprising:
a rear support;
a lip extending from said rear support, said lip comprising a plurality of extending protrusions from a base support, said protrusions have a rounded top portion;
a notch positioned between adjacent ones of the protrusions;
an end of said base support being coupled or attached to said rear support; and
a locking arm rotatably coupled to a respective one of the protrusions, the locking arm including one or more locking apertures,
wherein adjacent ones of the locking arms can be rotated to align the one or more locking apertures of respective locking arms of adjacent ones of the protrusions.

13. The rack of claim 12 wherein the aligned one or more locking apertures of respective locking arms are adapted to receive a locking member of a lock.

14. The rack of claim 12 wherein the locking arm is coupled with a pivot to a protrusion aperture positioned at top portion of the protrusion.

15. The rack of claim 12 wherein the locking arm includes three of the locking apertures arranged in a triangular pattern of 60 degrees to one another.

16. The rack of claim 12 wherein the notches include rounded corners.

17. The rack of claim 12 wherein each of the protrusions are the same size and each of the notches are the same size to allow the protrusions to be evenly spaced from one another.

18. The rack of claim 12 wherein the notch has a width W sufficient to accommodate a truck of a skateboard or a scooter and a pair of adjacent ones of the protrusions are adapted to retain respective skateboard wheels or scooter wheels.

19. The rack of claim 12 wherein the rear support and the lip are integral to one another.

20. The rack of claim 12 wherein the rack is formed of a one-piece construction of an extrusion of a metal or plastic material.

21. The rack of claim 12 wherein the rack is formed of recycled aluminum.

22. The rack of claim 12 wherein the rack comprises six or ten of the protrusions.

23. A locking device comprising:
a first locking arm member adapted to be pivotally attached to a first surface and a second locking arm member adapted to be pivotally attached to a second surface, the first and second locking arms each include a plurality of locking apertures,
wherein the first and second locking arms can be rotated to align one or more of the locking apertures of the first and second locking arms.

24. The rack of claim 23 wherein the aligned one or more locking apertures of respective locking arms are adapted to receive a locking member of a lock.

25. The rack of claim 23 wherein the locking arm includes three of the locking apertures arranged in a triangular pattern of 60 degrees to one another.

26. The rack of claim 12 wherein each of the protrusions is vertically symmetric around a vertical axis.

27. The rack of claim 12 wherein each of the protrusions has a bottom portion of a front wall that is curved and forms the base support.
